(19) United States
(12) Patent Application Publication
(10) Pub. No.: US 2016/0178423 A1
(43) Pub. Date: Jun. 23, 2016

(54) Flow Meters with Improved Blocking and Displacement Rotors

(71) Applicant: LIQUID CONTROLS GROUP, A UNIT OF IDEX CORPORATION, Lake Bluff (IL)

(72) Inventors: David T. Vaughn, Union Grove, WI (US); William J. Kolb, Lake Bluff, IL (US)

(73) Assignee: Liquid Controls LLC., Lake Bluff, IL (US)

(21) Appl. No.: 14/909,549

(22) PCT Filed: Jul. 10, 2014
(86) PCT No.: PCT/US14/46117

§ 371 Date: Feb. 2, 2016

Related U.S. Application Data
(60) Provisional application No. 61/844,468, filed on Jul. 10, 2013.

(51) Int. Cl. G01F 3/10

(52) U.S. Cl. CPC G01F 3/10

(57) ABSTRACT

A flow meter with a metallic case and bearing plates but with a blocking rotor and displacement rotors that are polymeric. The rotors may be sized for a reduced clearance between the rotors and surfaces of the case, bearing plates and blocking rotor. Using closer clearances between the rotors and the case bearing plates reduces leakage and provides for a more accurate measurement of the fluid through the flow meter.

### TECHNICAL FIELD

This disclosure relates to improvements in positive displacement fluid flow meters, and more particularly to a blocking rotor and displacement rotors for such flow meters.

### BACKGROUND

Diesel exhaust fluid (DEF) delivery systems, gasoline storage tanks, gasoline transport trucks, natural gas delivery systems and other fluid storage or delivery systems generally include a positive displacement flow meter connected in line in the fluid delivery system. Pumping of the fluid, whether gas or liquid, through the delivery line causes rotational movement of the rotors in the flow meter, which drives a mechanical or electrical counting device to precisely measure the volume of fluid flow through the meter.

Some flow meters have a housing that defines a cavity within which three rotors are rotatably mounted. The three rotors include a pair of displacement rotors and a blocking rotor disposed between the displacement rotors. One of the displacement rotors is disposed towards the inlet of the flow meter; the other displacement rotor is disposed towards the outlet. As the blocking rotor rotates, it mates with the inlet displacement rotor to close off part of the cavity to define a flow path along which the fluid must pass, thereby causing the displacement rotors and blocking rotor to rotate. The rotation of the displacement and blocking rotors creates a motion that correlates to the fluid volume passing through the meter, making it possible to translate the rotation of the displacement rotors into a meter reading showing fluid volume flow.

Currently, such flow meters typically have a stainless steel case and stainless steel rotors. Stainless steel is a material of choice because it can be used with a variety of liquids without corroding. However, while stainless steel has excellent chemical resistance properties, stainless steel is subject to galling. Specifically, when the clearance between a stainless steel rotor and the case is too narrow or insufficient, galling can occur. In contrast, use of a wider or more substantial clearance between the stainless steel rotor and the case may result in leakage, which adversely affects the accuracy of the measurement.

Therefore, there is a need for improved flow meters with improved displacement and/or blocking rotors.

### SUMMARY

In one aspect, flow meters with a blocking rotor and/or one or more displacement rotors fabricated from a chemical resistant polymer are disclosed.

In a refinement, flow meters with a blocking rotor and/or one or more displacement rotors fabricated from a polyaryletherketone (PAEK) are disclosed.

In a refinement, flow meters with a blocking rotor and/or one or more displacement rotors fabricated from polyether ether ketone (PEEK) are disclosed.

In another aspect, flow meters with a bearing plate that includes bearing inserts fabricated from a chemical resistant polymer are disclosed.

In a refinement, flow meters with a bearing plate that includes bearing inserts fabricated from a PAEK are disclosed.

In a refinement, flow meters with a bearing plate that includes bearing inserts fabricated from PEEK are disclosed.

In another refinement, the chemical resistant polymer, the PAEK or the PEEK may be reinforced with fibers, such as carbon or glass fibers or other suitable reinforcing fibers that will be apparent to those skilled in the art.

In another aspect, flow meters with bearing plates fabricated from a chemical resistant polymer are disclosed that may include metallic rotors.

In a refinement, flow meters with a blocking rotor and/or one or more displacement rotors fabricated from aluminum and bearing plates fabricated from a PAEK are disclosed.

In a refinement, flow meters with a blocking rotor and/or one or more displacement rotors fabricated from aluminum and bearing plates fabricated from PEEK are disclosed.

In another aspect, flow meters with polymeric bearing plates and metallic rotors may include metallic bearing inserts for receiving the journals of the metallic rotors.

### BRIEF DESCRIPTION OF THE DRAWINGS

FIG. 1 is a sectional view of a flow meter constructed in accordance with this disclosure, showing two displacement rotors and a blocking rotor within a case.

FIG. 2 is a plan view of a disclosed polymeric blocking rotor.

FIG. 3 is a sectional view taken substantially along line 3-3 of FIG. 2.

FIG. 4 is an end view of the blocking rotor shown in FIG. 2.

FIG. 5 is a sectional view taken substantially along line 5-5 of FIG. 4.

FIG. 6 is a plan view of a disclosed polymeric displacement rotor.

FIG. 7 is a bottom view of the displacement rotor shown in FIG. 6.

FIG. 8 is a sectional view taken substantially along line 8-8 of FIG. 7.

FIG. 9 is an end view of the displacement rotor as shown in FIG. 8.

FIG. 10 is a sectional view taken substantially along line 10-10 of FIG. 9.

FIG. 11 is an exploded view of a disclosed flow meter.

### DESCRIPTION

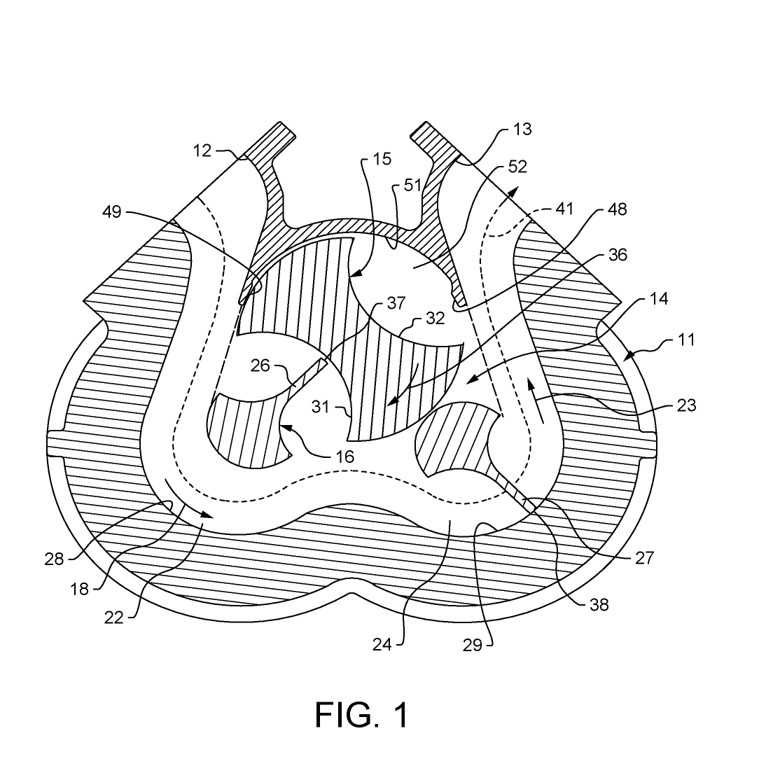

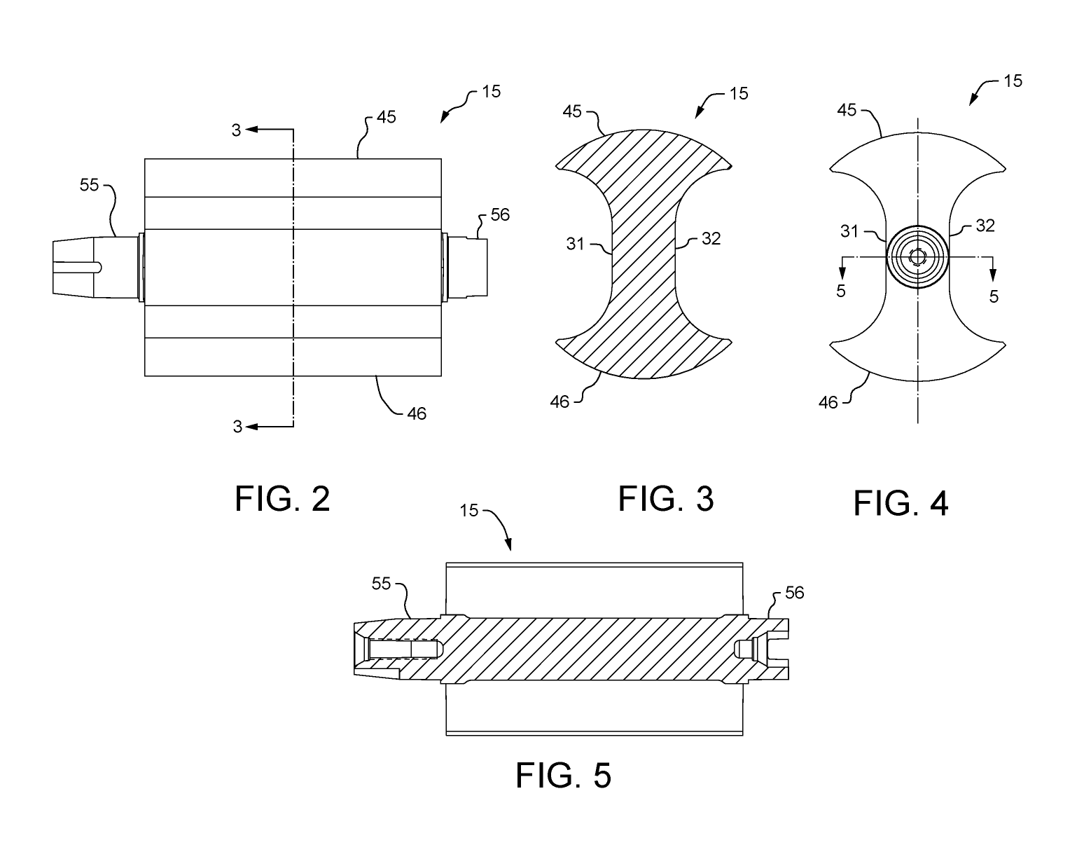

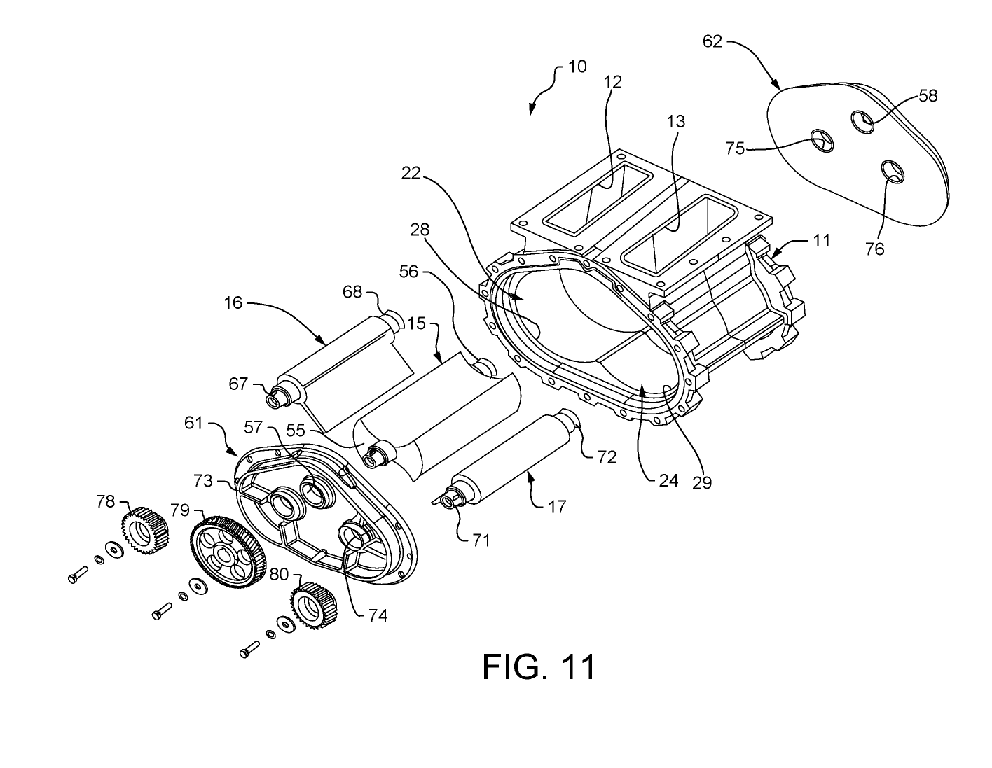

Turning first to FIG. 1, a flow meter 10 includes a case 11, an inlet port 12, an outlet port 13 and a cavity 14 that defines a flow path 41 and accommodates the rotors 15, 16, 17. The rotors 15, 16, 17 include a blocking rotor 15 and a pair of displacement rotors 16, 17, the designs of which are further illustrated in FIGS. 2-10. One or more of the rotors 15, 16, 17 may be fabricated from a polymeric material as opposed to a metallic material. For example, one or more of the rotors 15, 16, 17 may be fabricated from PEEK as opposed to stainless steel while the bearing plates 61, 62 (FIG. 11) and the case 11 may be fabricated from a metallic material, such as stainless steel. As an alternative, the bearing plates 61, 62 may be fabricated from a non-galling polymeric material such as a PAEK, e.g., PEEK, and the rotors 15, 16, 17 may be metallic, such as aluminum, an aluminum alloy or another suitable metallic material. Other materials may be used, as will be apparent to those skilled in the art.

Still referring to FIG. 1, the displacement rotor 16 will be referred to as the inlet displacement rotor 16 as it rotates in the direction of the arrow 18 thereby pumping fluid entering the inlet 12 along the flow path 41 and through the first arcuate chamber 22. The displacement rotor 17 will be referred to as the outlet displacement rotor 17 as it rotates in the direction of the arrow 23 and sweeps fluid from the second arcuate chamber 24 in the direction of the flow path 41 towards the outlet 13.

In the embodiment illustrated in FIG. 1, the case 11 forms the cavity 14 which, with the exception of the inlet and outlets 12, 13, forms a generally trefoil shape or clover shape due to the triangulated relationship between the blocking rotor 15 and inlet and outlet displacement rotors 16, 17. The cavity 14 includes the pair of arcuate pumping chambers 22, 24. As the displacement rotors 16, 17 rotate, the paddles 26, 27 of the displacement rotors 16, 17 sweep along the interior surfaces 28, 29 of the arcuate chambers 22, 24 to propel the liquid towards the outlet 13. The position of the displacement rotors 16, 17 and the length of the paddles 26, 27 also enables the paddles 26, 27 to sweep along the exterior surfaces 31, 32 of the concave walls 33, 34 of the blocking rotor 15 as the blocking rotor 15 rotates in the direction of the arrow 36.

The wiping contact between the distal ends 37, 38 of the paddles 26, 27 of the displacement rotors 16, 17 along the exterior surfaces 31, 32 of the blocking rotor 15 helps to keep from fluid leaking past the paddles 26, 27 when the paddles 26, 27 rotate along the concave walls 33, 34 so that the fluid passing through the flow meter 10 follows the flow path 41. Similarly, the distal ends 37, 38 of the paddles 26, 27 also make wiping contact with the surfaces 28, 29 of the arcuate chambers 22, 24 respectively.

To prevent galling that may be caused by such a wiping contact between a metallic displacement rotor and a surface of a metallic case or a surface of a metallic blocking rotor, the use of a PAEK, e.g., PEEK, as a material of construction for one or more of the rotors 15, 16, 17 is proposed. Again, as an alternative, PEEK or another suitable PAEK could be used for the bearing plates 61, 62 and the rotors 15, 16, 17 could be fabricated from a metal or metal alloy.

With the use of PEEK or another suitable PAEK as the material of construction for the rotors 15, 16, 17, the clearances between the distal ends 37, 38 of the paddles 26, 27 and the concave walls 31, 32 of the blocking rotor 15 as well as the clearance between the distal ends 37, 38 and the surfaces 28, 29 may be smaller or thinner than clearances required for stainless steel rotors and a stainless steel case. PEEK has been found to be particularly useful for flow meters as it is resistant to damage by most chemicals and it does not gall. While the tensile and beam strengths of PEEK and other PAEKs are much less than stainless steel, the coefficients of expansion of PEEK and other PAEKs are much greater than stainless steel, thereby enabling the use of closer tolerances. Further, the use of PEEK or other PAEKs for the rotors 15, 16, 17 eliminates the galling issue when running close clearances. Running closer clearances reduces the amount of leakage and allow for a more accurate measurement of the fluid through the flow meter 10. The increased accuracy will allow the flow meter 10 to be a certified weights and measure device. The final parts may be molded and then machined in order to provide a size tolerance of only about 0.0003″ (˜8 μm) on the blocking rotor 15 diameter and about 0.0002″ (˜5 μm) on the paddles 26, 27 and distal ends 37, 38 of the displacement rotors 16, 17.

Referring to the blocking rotor 15 and FIGS. 1-5, the blocking rotor 15 may be fabricated from a PAEK, such as PEEK, and may include a pair of concave surfaces 31, 32 that are disposed between and connected to a pair of convex surfaces 45, 46. The convex surfaces 45, 46 may engage protuberances 48, 49 that may be formed on the inner surface 51 of the third arcuate chamber 52 to limit leakage of fluid into the arcuate chamber 52 and maintain fluid flowing through the flow meter 10 along the flow path 41. The goal of the flow meter 10 is to provide as little impedance to the flow of fluid flowing between the inlet 12 and the outlet 13.

As seen in FIGS. 2 and 5, the blocking rotor 15 may include journals 55, 56. The journals 55, 56 may be integral to the rotor 15. The journals 55, 56 are received in the openings 57, 58 in the bearing plates 61, 62 respectively of the case 11 as shown in FIG. 11. The openings 57, 58 may be lined with a polymeric bearing insert. One suitable material for such bearing inserts is a PAEK, such as PEEK, especially if PEEK is used to fabricate the blocking rotor 15.

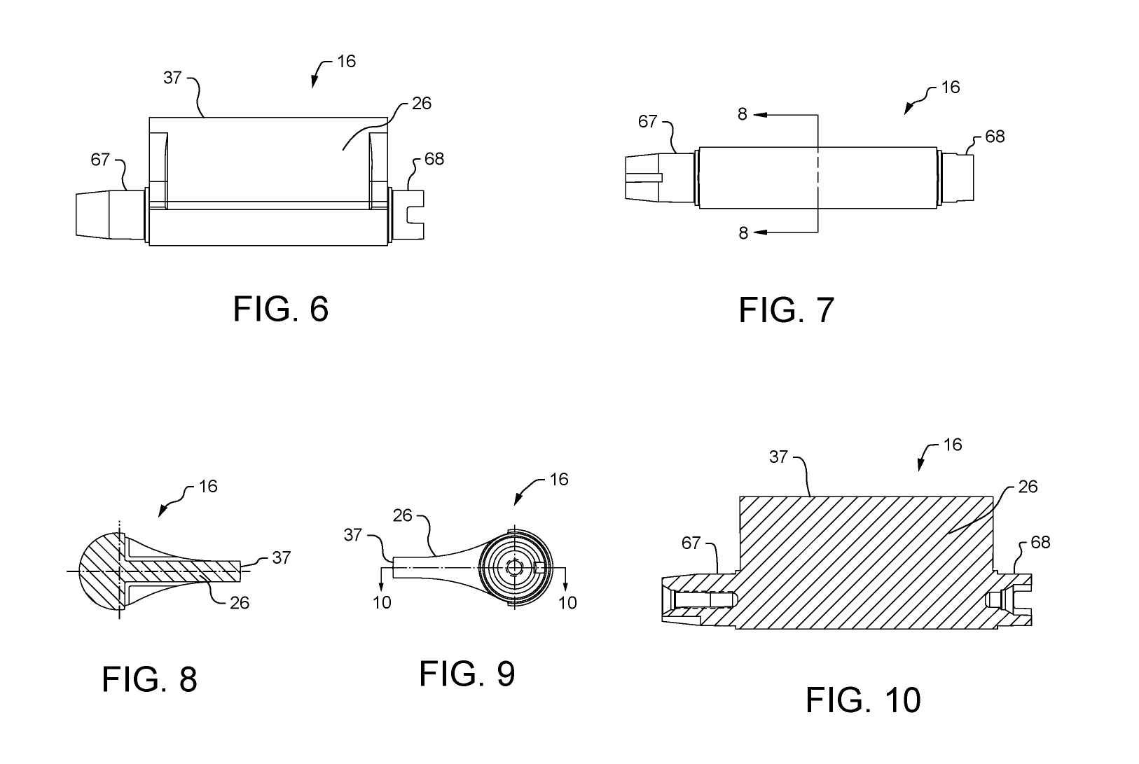

As seen in FIGS. 6-10, the displacement rotor 16 (or 17) includes a paddle 26 having a distal end 37. Referring to FIG. 11 as well as FIGS. 6-10, the displacement rotors 16, 17 may also include journals 67, 68 and 71, 72 that are received in the openings 73, 74 of the bearing plate 61 and the openings 75, 76 of the bearing plate 62. The openings 73-76 may also be lined with polymeric bearing inserts. The bearing inserts may be fabricated from a PAEK, such as PEEK, especially if the displacement rotors 16, 17 are fabricated from PEEK or another PAEK. All openings 57, 58, 73, 74, 75, 76 in the bearing plates 61, 62 may be lined with polymeric bearing inserts if the rotors 15, 16, 17 are also fabricated from a polymeric material.

Briefly turning to FIG. 11, an exploded view of the flow meter 10 is provided illustrating the two bearing plates 61, 62 and the case 11 in greater detail. Gears 78, 79, 80 are coupled to the journals 67, 55, 71 respectively and maintain the timing of the rotation of the three rotors 16, 15, 17.

### INDUSTRIAL APPLICABILITY

Thus, an improved flow meter 10 is disclosed that features durable blocking and displacement rotors 16 that may be fabricated from a polymer, such as PEEK or another PAEK. As an alternative, the bearing plates 61 of the case 11 may be fabricated from a polymer, such as PEEK or another PAEK, and the rotors 15 may be fabricated from a metal, such aluminum or an aluminum alloy.

1. A flow meter comprising:
a case defining a cavity with in inlet and an outlet, the case being disposed between and coupled to a pair of bearing plates, the bearing plates being fabricated from a metal;
a pair of displacement rotors with a blocking rotor disposed between the displacement rotors, the displacement and blocking rotors being fabricated from a polymer.

2. The flow meter of claim 1 wherein the polymer is a polyaryletherketone.

3. The flow meter of claim 1 wherein the polymer is polyetheretherketone.

4. The flow meter of claim 1 wherein the bearing plates are fabricated from stainless steel.

5. The flow meter of claim 2 wherein the bearing plates are fabricated from stainless steel.

6. The flow meter of claim 3 wherein the bearing plates are fabricated from stainless steel.

7. A flow meter comprising:
a case defining a cavity with in inlet and an outlet, the case being disposed between and coupled to a pair of bearing plates, at least the bearing plates being fabricated from a polymer;
a pair of displacement rotors with a blocking rotor disposed between the displacement rotors, the displacement and blocking rotors being fabricated from a metal.

8. The flow meter of claim 7 wherein the polymer is a polyaryletherketone.

9. The flow meter of claim 7 wherein the polymer is polyetheretherketone.

10. The flow meter of claim 7 wherein the rotors are fabricated from aluminum.
